(19) United States
(12) Patent Application Publication
(10) Pub. No.: US 2010/0093316 A1
(43) Pub. Date: Apr. 15, 2010

(54) METHOD, APPARATUS AND COMPUTER PROGRAM PRODUCT FOR PROVIDING AN INFORMATION ORGANIZATION MECHANISM

(75) Inventors: Klaus Franz Doppler, Espoo (FI); Antti Seppo Petteri Paananen, Tupos (FI); Adriana Vasilache, Tampere (FI); Shakeel Tabassam, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/248,462

(22) Filed: Oct. 9, 2008

(51) Int. Cl. H04M 3/42

(52) U.S. Cl. 455/414.1

(57) ABSTRACT

A method for providing an information organization mechanism may include receiving indications of event occurrences related to applications associated with a device and combining, within the device, selected ones of the indications in an event log. The event log may include indications related to at least one external event and at least one internal event. The method may further include providing notification of the selected indications via display of at least a portion of the event log. An apparatus and computer program product corresponding to the method are also provided.

### TECHNOLOGICAL FIELD

Embodiments of the present invention relate generally to information service technology and, more particularly, relate to a method, apparatus and computer program product for providing an information organization mechanism.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase the ease of information transfer and convenience to users relates to the provision of services to users of electronic devices. Given the popularity of the Internet, and the vast sources of information that are accessible using the Internet, various Internet services have evolved to provide users with information from a plurality of different sources. In this regard, for example, Internet services have evolved for use with personal computers (PCs) in order to provide such devices with a vast array of service to enable access to information.

With recent developments in the area of hand-held or mobile devices improving the capabilities of such devices, it may be desirable to develop mechanisms for providing mobile devices with improved functionality with respect to delivery of various services such as, for example, Internet services.

### BRIEF SUMMARY OF SOME EXAMPLES OF THE INVENTION

A method, apparatus and computer program product are therefore provided to provide an improved information organization mechanism. In some exemplary embodiments, indications of event occurrences associated with various different applications may be aggregated and/or filtered and the user may be notified of such occurrences in a customizable manner. As such, some exemplary embodiments of the invention may provide for an improved capability for users to receive information they desire in a manner they can control. Furthermore, some embodiments of the present invention may be employed on mobile devices so that, despite the limited capabilities of such devices relative to PCs or other devices with fewer limitations on size, cost and other factors, mobile devices may also enjoy a robust capability for receiving aggregated information. In an exemplary embodiment, information from both internal and external information sources may be aggregated within the device presenting such information. Furthermore, for example, an event log may be presented that includes both internal and external events in which the event log may not only present a record of such events, but further enable a user to access applications or services associated with each respective event recorded in the event log.

In an exemplary embodiment, a method of providing an information organization mechanism is provided. The method may include receiving indications of event occurrences related to applications associated with a device and combining, within the device, selected ones of the indications in an event log. The event log may include indications related to at least one external event and at least one internal event. The method may further include providing notification of the selected indications via display of at least a portion of the event log.

In another exemplary embodiment, a computer program product for providing an information organization mechanism is provided. The computer program product includes at least one computer-readable storage medium having computer-executable program code portions stored therein. The computer-executable program code portions may include first, second and third program code portions. The first program code portion may be for receiving indications of event occurrences related to applications associated with a device. The second program code portion may be for combining, within the device, selected ones of the indications in an event log. The event log may include indications related to at least one external event and at least one internal event. The third program code portion may be for providing notification of the selected indications via display of at least a portion of the event log.

In another exemplary embodiment, an apparatus for providing an information organization mechanism is provided. The apparatus may include a processor. The processor may be configured to receive indications of event occurrences related to applications associated with a device and combine, within the device, selected ones of the indications in an event log. The event log may include indications related to at least one external event and at least one internal event. The processor may be further configured to provide notification of the selected indications via display of at least a portion of the event log.

In yet another exemplary embodiment, an apparatus for providing an information organization mechanism is provided. The apparatus may include means for receiving indications of event occurrences related to applications associated with a device and means for combining, within the device, selected ones of the indications in an event log. The event log may include indications related to at least one external event and at least one internal event. The apparatus may further include means for providing notification of the selected indications via display of at least a portion of the event log.

Embodiments of the invention may provide a method, apparatus and computer program product for employment, for example, in mobile environments. As a result, for example, mobile device users may enjoy an improved capability for obtaining information via their respective computing devices.

### BRIEF DESCRIPTION OF THE SEVERAL VIEWS OF THE DRAWING(S)

Having thus described some embodiments of the invention in general terms, reference will now be made to the accompanying drawings, which are not necessarily drawn to scale, and wherein:

FIG. 1 illustrates one example of a communication system according to an exemplary embodiment of the present invention;

FIG. 2 illustrates a schematic block diagram of an apparatus for providing an information organization mechanism according to an exemplary embodiment of the present invention;

FIG. 3 (which includes FIGS. 3A and 3B) illustrates a screen shot of an exemplary notification according to an exemplary embodiment of the present invention;

FIG. 4 illustrates a screen shot of an exemplary event log and pinboard according to an exemplary embodiment of the present invention;

FIG. 5 shows an exemplary flowchart of operations that may be performed in accordance with user configuration updating according to an exemplary embodiment of the present invention;

FIG. 6 shows an exemplary flowchart of operations that may be performed for updating the configuration according to an exemplary embodiment of the present invention;

FIG. 7 shows an exemplary flowchart of operations that may be performed for returning to an old configuration according to an exemplary embodiment of the present invention; and

FIG. 8 is a flowchart according to an exemplary method for providing an information organization mechanism according to an exemplary embodiment of the present invention.

### DETAILED DESCRIPTION OF SOME EMBODIMENTS OF THE INVENTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Some embodiments of the present invention may provide a mechanism by which improvements may be experienced in relation to information organization. In this regard, for example, some embodiments may provide for a mechanism for aggregating information for presentation by a device such as a mobile terminal. However, unlike conventional external aggregation sites that are web based services for combining together information streams only from sources that are external to the device, embodiments of the present invention may enable the combination of both internal and external streams of information inside the device at which such information is to be presented. Thus, limitations associated with external aggregation sites may be overcome. Additionally, current mechanisms for providing aggregation of information streams or feeds (e.g., really simple syndication (RSS) feeds) to mobile devices utilize such external aggregation services, which may not offer users a desired level of customization capabilities. Exemplary embodiments of the present invention may overcome at least some of these limitations.

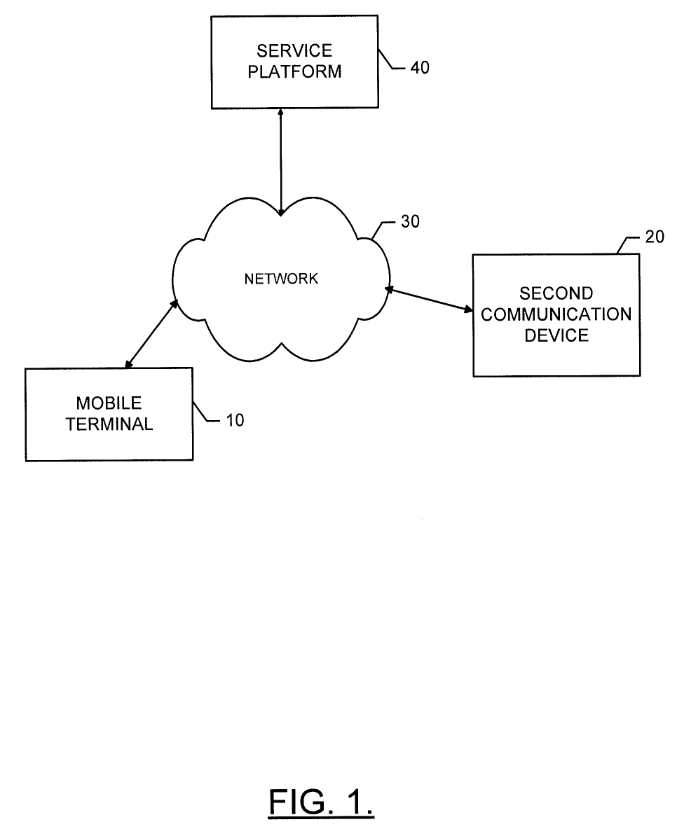

FIG. 1 illustrates a generic system diagram in which a device such as a mobile terminal 10, which may benefit from embodiments of the present invention, is shown in an exemplary communication environment. As shown in FIG. 1, an embodiment of a system in accordance with an example embodiment of the present invention may include a first communication device (e.g., mobile terminal 10) and a second communication device 20 capable of communication with each other via a network 30. In some cases, embodiments of the present invention may further include one or more network devices such as a service platform 40 with which the mobile terminal 10 (and possibly also the second communication device 20) may communicate to provide, request and/or receive information.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 and the second communication device 20 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the mobile terminal 10 and the second communication device 20 via the network 30. By directly or indirectly connecting the mobile terminal 10 and the second communication device 20 and other devices to the network 30, the mobile terminal 10 and the second communication device 20 may be enabled to communicate with the other devices or each other, for example, according to numerous communication protocols including Hypertext Transfer Protocol (HTTP) and/or the like, to thereby carry out various communication or other functions of the mobile terminal 10 and the second communication device 20, respectively.

Furthermore, although not shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In example embodiments, either of the first communication device and the second communication device 20 may be mobile or fixed communication devices. Thus, for example, the mobile terminal 10 and the second communication device 20 could be, or be substituted by, any of personal computers (PCs), personal digital assistants (PDAs), wireless telephones, desktop computer, laptop computers, mobile computers, cameras, video recorders, audio/video players, positioning devices, game devices, television devices, radio devices, or various other like devices or combinations thereof.

In an example embodiment, the service platform 40 may be a device or node such as a server or other processing element. The service platform 40 may have any number of functions or associations with various services. As such, for example, the service platform 40 may be a platform such as a dedicated server (or server bank) associated with a particular information source or service (e.g., an Internet service such as Google News, Newsvine, Digg, CNN, Yahoo or numerous other sources of information), or the service platform 40 may be a backend server associated with one or more other functions or services. As such, the service platform 40 may represent a plurality of different services or information sources. The functionality of the service platform 40 may be provided by hardware and/or software components configured to operate in accordance with known techniques for the provision of information to users of communication devices.

In an exemplary embodiment, the service platform 40 and the second communication device 20 may each represent sources for information that may be processed at the mobile terminal 10 in accordance with embodiments of the present invention. The mobile terminal 10 may then be configured to combine and aggregate both internal and external information sources (e.g., information streams) within the mobile terminal 10. In the context of embodiments of the present invention, external information streams may include RSS streams of news, videos, blog entries, etc., email headers, social network site updates, and/or the like. Meanwhile, internal information streams may include new call notifications, timeline or log events of calls that are created, received and/or missed, power management notifications, new message notifications, and/or the like. As such, an internal event may be defined as an event associated with a function of the mobile terminal 10 (e.g., SMS notification, missed calls, received calls, etc.), while an external event may be defined as an event coming from an external service (e.g., from an Internet service).

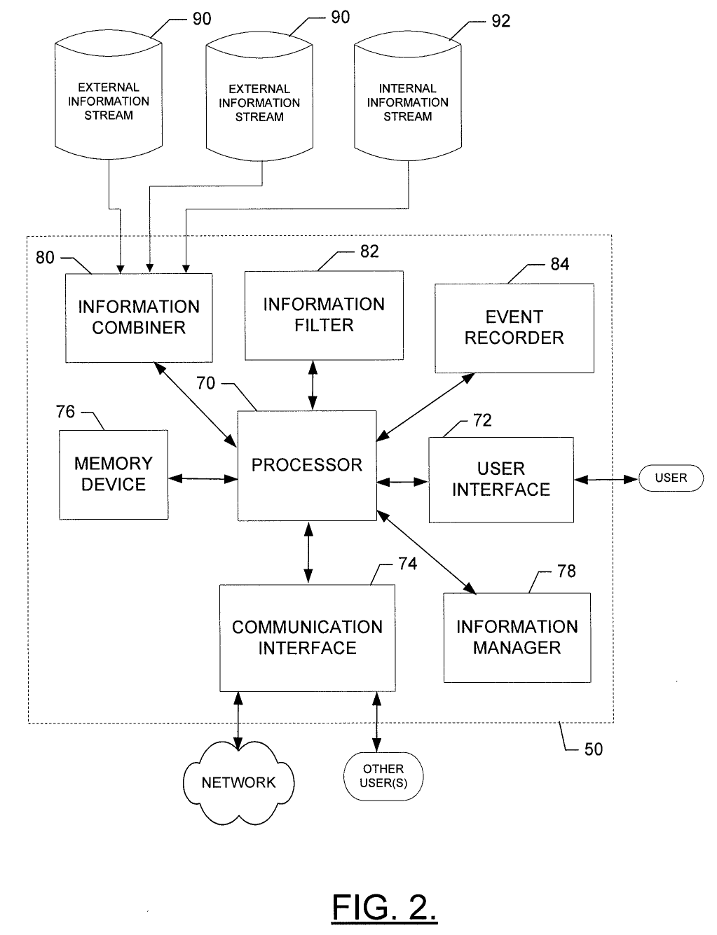

FIG. 2 illustrates a schematic block diagram of an apparatus for enabling the provision of an information organization mechanism according to an exemplary embodiment of the present invention. An exemplary embodiment of the invention will now be described with reference to FIG. 2, in which certain elements of an apparatus 50 for providing an information organization mechanism are displayed. The apparatus 50 of FIG. 2 may be employed, for example, on a communication device (e.g., the mobile terminal 10 and/or the second communication device 20) or a variety of other devices, both mobile and fixed (such as, for example, any of the devices listed above). Alternatively, embodiments may be employed on a combination of devices. Accordingly, some embodiments of the present invention may be embodied wholly at a single device (e.g., the mobile terminal 10) or by devices in a client/server relationship. Furthermore, it should be noted that the devices or elements described below may not be mandatory and thus some may be omitted in certain embodiments.

Referring now to FIG. 2, an apparatus for providing an information organization mechanism is provided. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like.

In an exemplary embodiment, the processor 70 may be embodied as, include or otherwise control an information manager 78, an information combiner 80, an information filter 82 and an event recorder 84. The information manager 78, the information combiner 80, the information filter 82 and the event recorder 84 may each be any means such as a device or circuitry embodied in hardware, software or a combination of hardware and software (e.g., processor 70 operating under software control) that is configured to perform the corresponding functions of the information manager 78, the information combiner 80, the information filter 82 and the event recorder 84, respectively, as described below. In some embodiments, communication between any or all of the information manager 78, the information combiner 80, the information filter 82 and the event recorder 84 may be conducted via the processor 70. However, some or all of the information manager 78, the information combiner 80, the information filter 82 and the event recorder 84 may alternatively be in direct communication with each other.

The information manager 78 may be configured to receive user input for customizing responses to received information from various sources and for enabling the user to select rules for defining such responses based on certain criteria. In some embodiments, the information manager 78 may be configured to enable the user to provide selections of specific services or applications for which event monitoring is to be conducted. The information manager 78 may also be configured to provide instructions to the information combiner 80, the information filter 82 and/or the event recorder 84 to direct operations of the information combiner 80, the information filter 82 and/or the event recorder 84, respectively, in accordance with rules, requests, profile information or other criteria specified by either default settings or user altered settings stored by or accessible to the information manager 78. In some embodiments, the information manager 78 may communicate with the user (e.g., via the user interface 72) and the information combiner 80, the information filter 82 and/or the event recorder 84 when the user makes selections affecting the customization of information selection, combination, and/or presentation.

In an exemplary embodiment, the information manager 78 may also be configured to monitor information received (e.g., via communication with the event recorder 84) in order to provide or direct the provision of notifications in specific situations. In this regard, for example, the information manager 78 may be configured to provide notifications (e.g., via the user interface 72) of specific events or occurrences. The information manager 78 may be further configured to enable the user to specify customized settings, rules or profile entries in order to direct operation of the event recorder 84 with respect to the provision of notifications. In some cases, notifications may take the form of entries in a timeline or event log maintained by the event recorder 84. As such, in some embodiments, the event recorder 84 may, based on stored instructions or instructions received from the information manager 78, provide notifications to the user. In alternative embodiments, the notifications may be popup entries and/or various sounds, graphics, alarms or other mechanisms for getting the user's attention. The notifications may, in some cases, include text, sound, image data or other information indicative of the event occurrence triggering the notification. The information indicative of the event may be specific or generic. For example, if an event trigger is provided for a particular sport or topic, an icon associated with the application reporting or receiving information associated with the sport may be provided and a modification to the icon may be provided in response to the trigger. If the information indicative of the event is generic, the modification may simply state “new” or otherwise generically indicate that an update is available. Meanwhile, for example, if the information indicative of the event is specific, the modification may state “score update” or give at least a portion of content associated with the event.

By selecting the notification, icon or modification to the icon, the user may be directed to the corresponding application or service. Thus, for example, if an event entry relates to a YouTube video, titles of videos may be presented according to a pre-defined filter (e.g., 10 most popular) or to a filter set by the user (e.g., new videos with certain keywords). In response to selection of a YouTube event entry, streaming of a corresponding video may be initiated. Additionally, the list of titles may be displayed in a pop-up window or expanded within the display. The list of titles may also be obtained automatically, without user intervention and the user may be notified that such videos are available. As another example, if an email entry or notification, the user may be directed to the email inbox. As yet another example, a notification regarding a recent blog entry or comment may be selected in order to display the recent blog entry or comment. Accordingly, for each notification, embodiments of the present invention may enable a relatively easy and uncomplicated mechanism by which a user can access a related service or application without navigating through different screens and/or menus. In some instances, selecting an event entry or notification may result in the provision or offering of options related to execution of the associated service/application. In this regard, for example, selecting a particular notification or event entry may provide the user with options to execute a corresponding client, preview content, download content, and/or execute other like options.

Notably, notifications made by the information manager 78 or made by the event recorder 84 based on directions provided by the information manager 78 may not only be related to a single event. For example, correlations between events associated with the same individual, the same time, the same information source, the same event, or other similar correspondences may be made by the information manager 78 in order to enable special notifications of the other events or entries that may be related to a particular (perhaps current) event or entry. As an exemplary use case of an example embodiment of the present invention, an email may be sent to the mobile terminal 10 (e.g., from the second communication device 20). Information about the email may be received via an external information stream. The second communication device 20 may also send a short message service (SMS) message to the mobile terminal 10 on the same day. The information regarding the SMS may be received via an internal information stream. When the second communication device 20 calls shortly after sending the SMS, the combination logic of the information combiner 80 may be matched and a special notification may be performed to notify the user of the mobile terminal 10 that the call is coming from the user of the second communication device 20 and that the user of the second communication device previously emailed and sent the SMS. In some embodiments, the notification may also include the subject line and/or content from the email and/or the SMS.

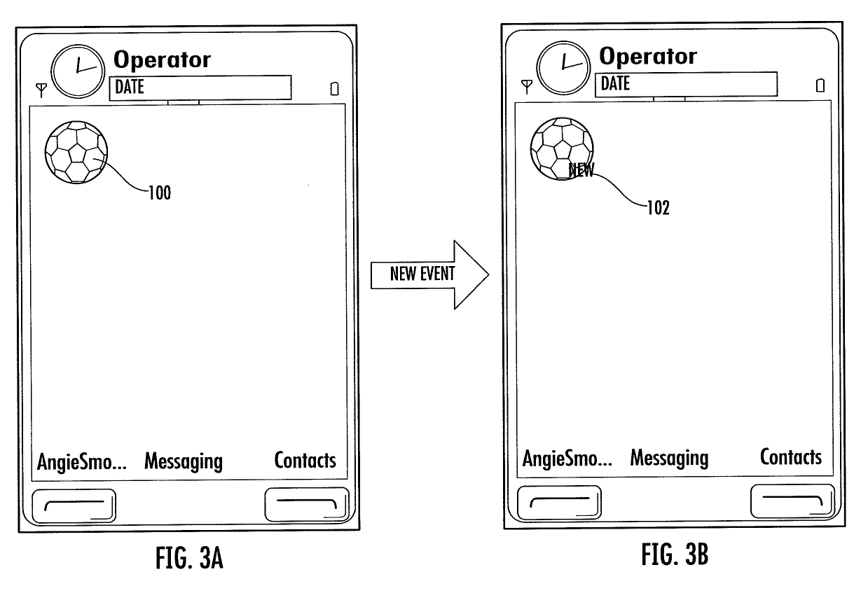

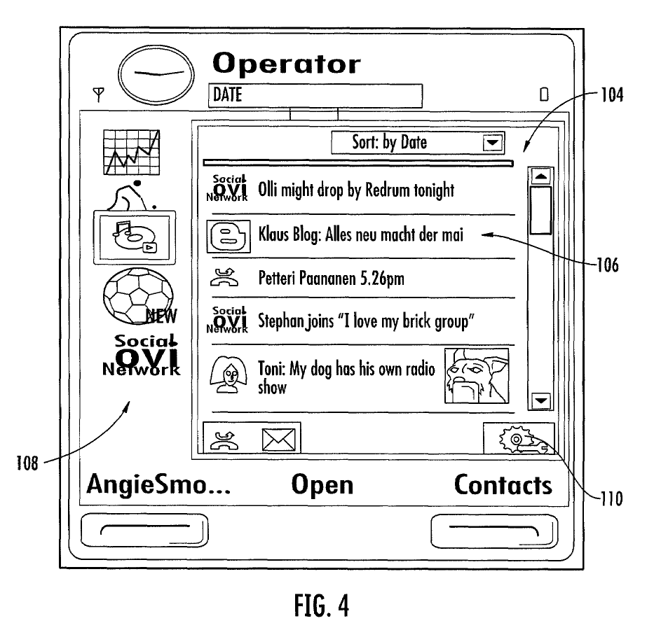

FIG. 3A shows an example of an icon 100 that may be associated with an application for monitoring a sports feed (or set of sports feeds) specifically related to a soccer game, soccer games or news regarding selected teams. In response to a new event occurrence (e.g., the scoring of a goal), a visual notification 102 may be provided by the information manager 78 as shown in FIG. 3B. FIG. 4 shows an example of an alternative notification scheme in which an event log 104 is provided to show a sortable (e.g., by date, application, time, subject matter, etc.) listing of notifications of various different event occurrences. As shown in FIG. 4, specific event notifications (e.g., notification 106) may be provided in a list format that may include information regarding which application each notification is associated with, the time of the notification, a portion of the content of the notification (e.g., a subject of the notification, summary of the event, video clip, message subject line, caller or message sender identification, and/or numerous other like pieces of information), and/or the like.

The information combiner 80 may be configured to perform aggregation or combinations of information (e.g., information streams) received from various internal and external sources. In this regard, for example, the information combiner 80 may include combination logic configured to combine streams of information. In some cases, the combination logic of the information combiner 80 may be guided in operation according to rules, settings, programming or profile information provided via the information manager 78. The information combiner 80 may be configured to enable the combination of multiple internal streams, multiple external streams or combinations of multiple internal and external streams. Unlike conventional aggregation services that operate externally (e.g., at a server accessible via the Internet), the information combiner 80 may provide combination capability for both internal and external information sources within the mobile terminal 10 or other device in which the information combiner 80 may be instantiated.

As shown in FIG. 2, the information combiner 80, may combine information from one or more external information sources (e.g., external information streams 90) and/or internal information sources (e.g., internal information stream 92). After the information sources are combined by the information combiner 80, the combined information may be filtered by the information filter 82 in order to generate a combined or aggregated information source that may, for example, be fed to or monitored by the event recorder 84. In some cases, notifications may be issued based on the combined or aggregated information source by the event recorder 84 and/or the information manager 78.

The information filter 82 may be configured to filter data provided from the information combiner 80 in order to produce a resultant output that conforms to instructions provided from the information manager 78. In an exemplary embodiment, the information filter 82 may be guided in operation by rules, settings, programming or profile information provided via the information manager 78. In this regard, for example, the information filter 82 may filter out certain events or notifications for events related to information sources monitored according to filtering criteria provided by the information manager 78. The filtering criteria may include such factors as priority (e.g., a priority of the service, application, communication channel and/or the like as set by the user), relevance (e.g., utilizing an algorithm for determining how often the user utilizes a particular application, monitors a particular information source, communicates with a particular individual, engages in a particular activity, and/or the like), and/or by sender (e.g., with respect to an alphabetical listing, relationship with the user, frequency of contact, and/or the like). Filtration may impact the inclusion and/or ordering of various events or pieces of information in the combined information source.

The event recorder 84 may be configured to record events detected or monitored among various information sources (e.g., information streams) in a timeline or log (e.g., the event log 104). As indicated above, the event recorder 84 may record events by any of various different sortable criteria such as date, time, application, subject matter, a contact identifier (e.g., of a sender), priority, relevance, and/or the like. As shown in FIG. 4, an icon or distinctive identifier for each application may accompany each respective event log entry to indicate the application or communication channel from which the entry was received. Other information including content, a portion of the content, or information summarizing or descriptive of the content may also be presented along with the icon or distinctive identifier. In cases where the listing of recorded events exceeds the length of the display screen, settings may be altered to modify the presentation scheme in a desirable fashion. For example, font size, the amount, type or class of information presented, the number of entries per page, and/or the like, may be selectable by the user to enable display customization. Alternatively, a slider bar may be provided to shift a field of view of displayed entries to cover a portion relative to the entire list.

In an exemplary embodiment, the event recorder 84 may be configured to record all events that meet criteria provided by the information manager 78. As such, for example, the event recorder 84 may monitor information sources provided by the information combiner 80 (e.g., a combined or aggregated information stream, or each information source capable of providing information to the information combiner 80) and record each event that meets recordation criteria. In some cases, the event recorder 84 may not actively monitor information sources for recordable information, but may instead enable such information sources (e.g., communication channels, applications, services, etc.) to write events directly to the event log 104. In some embodiments, the event recorder 84 may then generate the event log 104 including all or selected ones of the recorded or written events. For example, the event recorder 84 may generate the event log 104 based only on events corresponding to filter criteria in the information filter 82.

The event recorder 84 may provide the event log 104 as a pinboard or repository for notifications either selected by the user (e.g., sporting results, specifically identified blogs, social network interactions, and/or the like) or default notifications (e.g., missed calls, new emails, new messages, and/or the like). In an exemplary embodiment in which the event log 104 is provided in a pinboard format, as shown in FIG. 4, the user may be enabled to drag and drop applications into a selection area 108 of the pinboard (e.g., via moving an icon of the application or communication channel) or may otherwise select applications from a listing of applications (e.g., by flagging applications or communications channels in the list that are to be monitored by the event recorder 84) in order to select those application for which events are to be recorded and/or considered for inclusion in the event log 104. However, if removal of particular applications or communication channels is desired, the application or channel desired for removal may be removed from the selection area 108 (e.g., by drag and drop or deletion) or the application or communication channel may be unselected or unflagged. In various examples, the drag and drop functionality may be employed on touch screen embodiments or embodiments with a cursor, while the list based selection embodiments may be practiced in connection with the use of soft keys and/or an options or settings icon (e.g., settings icon 110 from FIG. 4). Accordingly, for example, users may be enabled to relatively easily add an application to the pinboard for event monitoring and, if a particular event for which a notification or log entry is received is of interest, users may also be enabled to relatively easily access more detailed information about the notification or entry by merely selecting the notification or entry. For example, YouTube, an email application, a particular blog application (such as the examples described above) or any of numerous other applications may be added to the service area 108 to provide monitoring of events for such applications and enable click through access to such applications via selection of corresponding events.

In some embodiments, the pinboard may further include an option for hiding or deleting specific entries. In this regard, for example, when a particular entry is highlighted, a delete or hide button may be selected in order to remove unimportant events or events for which the user has already responded. In some cases, an unhide button may also be presented in order to enable the user to make hidden items visible again.

In an exemplary embodiment, the event log 104 may be provided on the home screen (or idle screen) of the mobile terminal 10. In some cases, notifications of particular events may be recorded in the event log 104, but also occurrences of particular events (e.g., without any specific notification) may also be recorded in the event log 104 to provide a robust recording of events and notifications provided by the event log 104. In an exemplary embodiment, items within the event log 104 may be selected in order to access further or more complete information about the respective entry. In some embodiments, selection of a particular notification (e.g., notification 106) may activate a link to or otherwise access further information about the entry, activate a link to the corresponding information source, channel or application, activate a link to options such as mechanisms for setting or changing priority or other characteristics of the corresponding entry item, and/or the like.

In an exemplary embodiment, an example of an event for which further information or functionality to which the user may be linked is accessible, may include a changing of device configuration settings. In this regard, for example, the event log 104 may include events such as configuration changes. Previously, mobile terminals were typically configured using web services that send text messages to the terminals after configuration. The user then saves the new configuration received in the text message and employs the saved configuration. However, if the user decides that the new configuration is undesirable and wishes to return to the old configuration, the user typically has to search for an old configuration message in order to return to the old configuration. If the message is deleted, the old configuration may not be easily recovered. Moreover, even if the message is not deleted, such message may be difficult to locate. Furthermore, in some cases the configuration may be of a size too large to fit in a single text message.

Accordingly, embodiments of the present invention may enable the user to access previous configuration information by finding configuration messages (e.g., by sorting) in the event log 104. The user may then select the entry corresponding to the desired configuration and retrieve the desired configuration. In practice according to one exemplary embodiment, historical configuration information may be stored by a web configuration service and such information may be accessible via the event log 104. Configuration messages (including messages for retrieving old configurations) may be forwarded to the mobile terminal 10 via a feed mechanism (e.g., ATOM, RSS feed, etc.). In an exemplary embodiment, a predetermined number of configurations may be kept to be accessible to the user by the above described retrieval mechanism. Alternatively, old configurations may be kept for a predetermined length of time. The configuration information may relate to home screen layout or numerous other configurable features. In some embodiments, the configuration information may define such factors as which events should be displayed by the service, what response should be provided if the user selects a log entry (e.g., show latest 10 videos for YouTube, 10 most popular, 10 videos that contain a particular keyword, and/or numerous other examples), and/or the like.

In some embodiments, configuration changes may be selected and/or otherwise effected via another device than the device being configured. For example, the second communication device 20 may be a PC of the user and the user may use a configuration application on the second communication device 20 to define configuration settings for the home screen of the mobile terminal 10. An RSS reader may then detect that new configuration settings have been defined for the mobile terminal 10 the next time the user is using their mobile terminal 10 and the user may select an option to load the configuration settings (e.g., in response to a notification of the event). Alternatively, a direct connection between the mobile terminal 10 and a web service may be established (e.g., to display the device with its current settings). In response to selection of the option to load the configuration settings, new applications, services, plugins, and or other configuration information may be taken into use at the mobile terminal 10. Later on, if the user desires to return to the old settings, the user may return to the event log 104 to select the old configuration from the event log entry corresponding to the configuration change. In some cases, by selecting a configuration entry, the user may be prompted with a menu option such as an option for returning to the old configuration settings. Either the corresponding old configuration setting or a listing of prior configuration settings may then be provided from which the user may select one and initiate loading of the selected configuration via the feed mechanism.

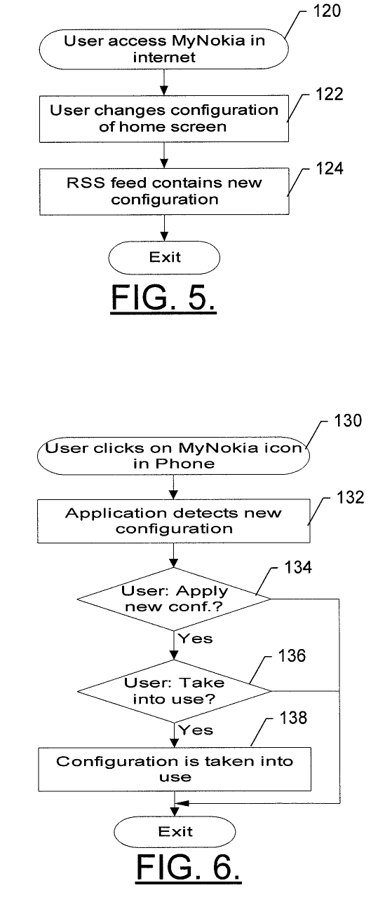

FIG. 5 shows an exemplary flowchart of operations that may be performed in accordance with user configuration updating according to an exemplary embodiment. In this regard, as shown at operation 120, the user may access an application configuration service (e.g., “MyNokia”) via the network 40 (e.g., the Internet) and/or execute a configuration application. At operation 122, the user may change configuration information (e.g., home screen configuration settings). The configuration settings may then be added to the mobile terminal 10 via a feed mechanism (e.g., RSS feed) at operation 124. In some cases, the configuration service may request a model or other identification number of the mobile terminal 10 to offer additional services. Such information may be provided from a user profile or directly by the user. In an alternative mechanism, the user may launch a configuration application, which may then connect to the configuration service to enable the configuration service to access the identification number of the mobile terminal 10 and the current configuration. Current configuration information may otherwise be assumed to be the last configuration loaded.

FIG. 6 shows an exemplary flowchart of operations that may be performed for updating the configuration according to an exemplary embodiment. In this regard, for example as shown at operation 130, the user may select a configuration application in the mobile terminal 10. The application may then detect a new configuration (e.g., via RSS feed) at operation 132. The user may be asked whether the new configuration is to be applied at operation 134. It the user answers “yes”, a preview of the new configuration may be displayed and/or the user may select to take the new configuration into use at operation 136. If the user selects “yes”, the configuration is taken into use at operation 138 and activated.

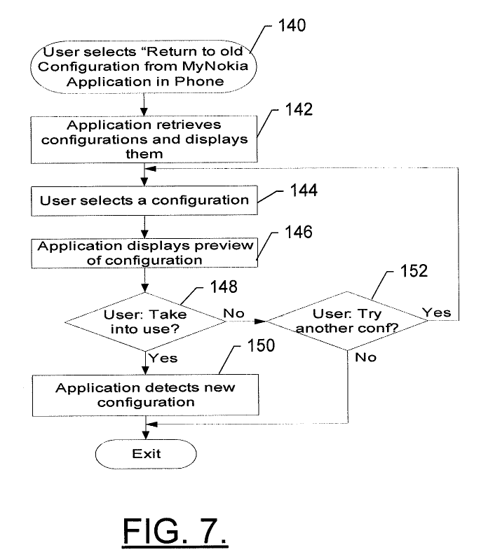

FIG. 7 shows an exemplary flowchart of operations that may be performed for returning to an old configuration according to an exemplary embodiment. At operation 140, the user may select an option for returning to old configuration settings. The configuration application may then retrieve information on old configurations and display them to the user at operation 142. Supported choices (e.g., based on configuration creation date, duration of activity, descriptive name (e.g., chosen by the user during creation or automatically named using some convention), and/or the like) may be previewable. The user may select a configuration at operation 144 and a preview of the selected old configuration may be displayed at operation 146. The user may then be offered an option to take the old configuration into use at operation 148. If the user takes the old configuration into use, the configuration application may detect the old configuration and the old configuration may be added to the mobile terminal 10 via the feed mechanism (e.g., in a fashion similar to that described in relation to FIG. 6 above) at operation 150. If the user does not wish to select the previewed configuration, the user may try to select another configuration at operation 152.

In an exemplary embodiment, each device registered to the configuration service may be assigned a dedicated feed mechanism (e.g., RSS feed such as RSS 1.0, RSS 2.0, Atom or the like) that may include the configuration data of the user or device. Due to the provision of configuration information by the feed mechanism, configuration data may not be limited in size (e.g., to the maximum size of a text message). Configuration data for home or idle screen configuration as well as many other types of configuration information may be provided by this mechanism. Additionally, configurations may be shared between multiple terminals, devices and/or users. In this regard, for example, a user may provide a configuration to a friend by simply forwarding the configuration to an RSS feed address.

In addition to providing configuration information to friends, other social interactions may be accomplished via embodiments of the present invention. In this regard, for example, the event recorder 84 may be configured (e.g., via the information manager 78) to enable the writing of information, events, postings, etc., related to or initiated by specific individuals, to be posted directly to the event log 104. Thus, for example, an application such as a social networking application (e.g., Facebook, mySpace, Ovi Social network, or the like) may be enabled to directly write information posted by or related to individuals identified by the user (e.g., in a contact list or otherwise specifically identified) to the event log 104. Alternatively or additionally, information regarding the activities of the individuals (in some cases subject to permission from the respective individuals) may be posted to the event log 104 as recorded events. As examples, now playing information for a particular friend, current location of the friend (e.g., entry within a predefined threshold proximity to the user), calendar entries for the friend, text messages, blog entries, multimedia postings, and/or the like, may be posted directly to the event log 104 or pinboard.

The user may be enabled (e.g., via the information manager 78) to select the contacts or individuals that can provide postings directly to the event log 104 or about whose activities the event log 104 may report. In some embodiments, the user may further select those applications in association with which particular contacts or individual activities and/or postings are to be monitored. In an exemplary embodiment, the individuals may be selected via a corresponding social network service application selected or via a phonebook (e.g., when selecting options). In an exemplary embodiment, when selecting a social networking entry and hovering over or highlighting the entry for a predetermined length of time after selection of the corresponding application from the selection area 108 of the pinboard, an option may be provided to select the corresponding entry for monitoring by the event recorder 84. In some cases features of the highlighted entry may also be enlarged to facilitate inspection of such entries.

Accordingly, the event recorder 84 may be configured to display or include in the event log 104 relevant information from different applications (e.g., music player, email, etc.), communication channels (e.g., blog, chat, instant message, etc.), services (e.g., music services, news feeds, etc.), and/or the like. The event recorder 84 may also be configured to combine notifications selected by the user along with default locations into a single presentable format (e.g., the event log 104 of the pinboard). The user may be enabled to organize the information of the pinboard by sorting the information according to various criteria described above. The applications and/or communication channels from which information for the pinboard may be gathered may be selected (e.g., by dragging and dropping icons in the selection area or by flagging applications to be monitored). Priorities and/or other criteria may be established to guide the event recorder 84 in relation to determining which events to record and/or how to present such event recordings to the user. Furthermore, in some cases, other users may be given permission to post directly to the event log 104 of the mobile terminal 10.

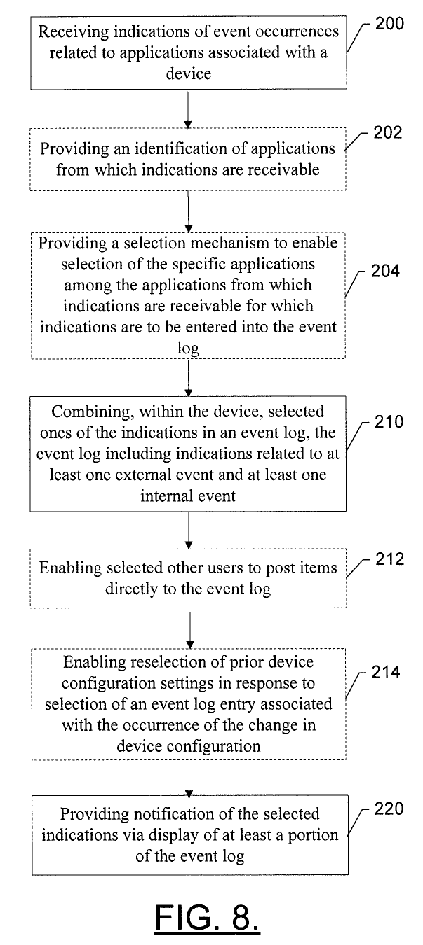

FIG. 8 is a flowchart of a system, method and program product according to some exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or other apparatus employing embodiments of the present invention and executed by a processor in the mobile terminal or other apparatus. As will be appreciated, any such computer program instructions may be loaded onto a computer or other programmable apparatus (i.e., hardware) to produce a machine, such that the instructions which execute on the computer (e.g., via a processor) or other programmable apparatus create means for implementing the functions specified in the flowchart block(s) or step(s). These computer program instructions may also be stored in a computer-readable memory that can direct a computer (e.g., the processor or another computing device) or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing an information organization mechanism as illustrated, for example, in FIG. 8 may include receiving indications of event occurrences related to applications associated with a device at operation 200 and combining, within the device, selected ones of the indications in an event log at operation 210. The event log may include indications related to at least one external event and at least one internal event. The method may further include providing notification of the selected indications via display of at least a portion of the event log at operation 220.

In some embodiments, the method may include further optional operations, examples of which are shown in dashed lines in FIG. 8. Any or all of the optional operations may be performed in combination with each other in various alternative embodiments. As such, the method may further include enabling selected other users to post items (e.g., audio, video, pictures, text, (automatically generated) location information, (automatically generated) information about a current activity, etc.) directly to the event log at operation 212. In some embodiments in which combining selected ones of the indications comprises recording indications related to specific applications selected by a user of the device, the method may further include providing an identification of applications from which indications are receivable at operation 202 and providing a selection mechanism to enable selection of the specific applications among the applications from which indications are receivable for which indications are to be entered into the event log at operation 204. In some embodiments in which combining selected ones of the indications comprises recording an occurrence of a change in device configuration in the event log, the method may further include enabling reselection of prior device configuration settings in response to selection of an event log entry associated with the occurrence of the change in device configuration at operation 214. Additional operations that may be provided may include sorting of events in the event log based on user selectable criteria and enabling access to an application associated with a recorded event via selection of a corresponding event entry.

In some embodiments, certain ones of the operations above may be modified or further amplified as described below. It should be appreciated that each of the modifications or amplifications below may be included with the operations above either alone or in combination with any others among the features described herein. In this regard, for example, providing the notifications may include providing the event log on a home screen of the device. In some embodiments, combining selected ones of the indications for external events may include recording information from sources for external events including feed streams, emails and social network communications and combining selected ones of the indications for internal events may include recording information from sources for internal events including call related notifications, power management notifications and message notifications. In an exemplary embodiment, combining selected ones of the indications for external events and internal events may include combining and filtering external information streams and internal information streams. In some embodiments, providing notification of the selected indications may include providing an aggregation of the external and internal information streams in which the aggregation is performed within the device.

In an exemplary embodiment, an apparatus for performing the method of FIG. 8 above may comprise a processor (e.g., the processor 70) configured to perform some or each of the operations (200-220) described above. The processor may, for example, be configured to perform the operations (200-220) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-210 may comprise, for example, the processor 70, respective ones of the information manager 78, the information combiner 80, the information filter 82, and the event recorder 84, or an algorithm executed by the processor for organizing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving indications of event occurrences related to applications associated with a device;
combining, within the device, selected ones of the indications in an event log, the event log including indications related to at least one external event and at least one internal event; and
providing notification of the selected indications via display of at least a portion of the event log.

2. The method of claim 1, wherein providing the notifications comprises providing the event log on a home screen of the device.

3. The method of claim 1, wherein combining selected ones of the indications comprises recording indications related to specific applications selected by a user of the device.

4. The method of claim 3, further comprising providing an identification of applications from which indications are receivable; and providing a selection mechanism to enable selection of the specific applications among the applications from which indications are receivable for which indications are to be entered into the event log.

5. The method of claim 1, wherein combining selected ones of the indications comprises recording an occurrence of a change in device configuration in the event log.

6. The method of claim 5, further comprising enabling reselection of prior device configuration settings in response to selection of an event log entry associated with the occurrence of the change in device configuration.

7. The method of claim 1, further comprising enabling selected other users to post items directly to the event log.

8. The method of claim 1, wherein combining selected ones of the indications for external events comprises recording information from sources for external events including feed streams, emails and social network communications and wherein combining selected ones of the indications for internal events comprises recording information from sources for internal events including call related notifications, power management notifications and message notifications.

9. The method of claim 1, wherein combining selected ones of the indications for external events and internal events comprises combining and filtering external information streams and internal information streams.

10. The method of claim 9, wherein providing notification of the selected indications comprises providing an aggregation of the external and internal information streams in which the aggregation is performed within the device.

11. The method of claim 1, further comprising enabling sorting of events in the event log based on user selectable criteria.

12. The method of claim 1, further comprising enabling access to an application associated with a recorded event via selection of a corresponding event entry.

13. A computer program product comprising at least one computer-readable storage medium having computer-executable program code portions stored therein, the computer-executable program code instructions comprising:
first program code instructions for receiving indications of event occurrences related to applications associated with a device;
second program code instructions for combining, within the device, selected ones of the indications in an event log, the event log including indications related to at least one external event and at least one internal event; and
third program code instructions for providing notification of the selected indications via display of at least a portion of the event log.

14. The computer program product of claim 13, wherein the third program code instructions include instructions for providing the event log on a home screen of the device.

15. The computer program product of claim 13, wherein the second program code instructions include instructions for recording indications related to specific applications selected by a user of the device.

16. The computer program product of claim 15, further comprising fourth program code instructions for providing an identification of applications from which indications are receivable; and fifth program code instructions for providing a selection mechanism to enable selection of the specific applications among the applications from which indications are receivable for which indications are to be entered into the event log.

17. The computer program product of claim 13, wherein the second program code instructions include instructions for recording an occurrence of a change in device configuration in the event log.

18. The computer program product of claim 17, further comprising fourth program code instructions for enabling reselection of prior device configuration settings in response to selection of an event log entry associated with the occurrence of the change in device configuration.

19. The computer program product of claim 13, further comprising fourth program code instructions for enabling selected other users to post items directly to the event log.

20. The computer program product of claim 13, wherein the second program code instructions include instructions for combining and filtering external information streams and internal information streams.

21. The computer program product of claim 13, further comprising fourth program code instructions for enabling sorting of events in the event log based on user selectable criteria.

22. The computer program product of claim 13, further comprising fourth program code instructions for enabling access to an application associated with a recorded event via selection of a corresponding event entry.

23. An apparatus comprising a processor configured to:
receive indications of event occurrences related to applications associated with a device;
combine, within the device, selected ones of the indications in an event log, the event log including indications related to at least one external event and at least one internal event; and
provide notification of the selected indications via display of at least a portion of the event log.

24. The apparatus of claim 23, wherein the processor is configured to provide the notifications by providing the event log on a home screen of the device.

25. The apparatus of claim 23, wherein the processor is configured to combine selected ones of the indications by recording indications related to specific applications selected by a user of the device.

26. The apparatus of claim 25, wherein the processor is further configured to provide an identification of applications from which indications are receivable; and provide a selection mechanism to enable selection of the specific applications among the applications from which indications are receivable for which indications are to be entered into the event log.

27. The apparatus of claim 23, wherein the processor is configured to combine selected ones of the indications by recording an occurrence of a change in device configuration in the event log.

28. The apparatus of claim 27, wherein the processor is further configured to enable reselection of prior device configuration settings in response to selection of an event log entry associated with the occurrence of the change in device configuration.

29. The apparatus of claim 23, wherein the processor is further configured to enable selected other users to post items directly to the event log.

30. The apparatus of claim 23, wherein the processor is configured to combine selected ones of the indications for external events and internal events by combining and filtering external information streams and internal information streams.

31. The apparatus of claim 30, wherein the processor is configured to provide notification of the selected indications by providing an aggregation of the external and internal information streams in which the aggregation is performed within the device.

32. The apparatus of claim 23, wherein the processor is further configured to enable sorting of events in the event log based on user selectable criteria.

33. The apparatus of claim 23, wherein the processor is further configured to enable access to an application associated with a recorded event via selection of a corresponding event entry.

34. An apparatus comprising:
means for receiving indications of event occurrences related to applications associated with a device;
means for combining, within the device, selected ones of the indications in an event log, the event log including indications related to at least one external event and at least one internal event; and
means for providing notification of the selected indications via display of at least a portion of the event log.

35. The apparatus of claim 34, wherein means for combining selected ones of the indications comprises means for recording an occurrence of a change in device configuration in the event log.
